(19) United States
(12) Patent Application Publication
(10) Pub. No.: US 2021/0127199 A1
(43) Pub. Date: Apr. 29, 2021

(54) EARPHONE WITH UNIFORM ACOUSTIC IMPEDANCE

(71) Applicant: MrSpeakers, LLC, San Diego, CA (US)

(72) Inventors: Daniel William Clark, San Diego, CA (US); Robert Jason Egger, San Diego, CA (US)

(21) Appl. No.: 16/666,060

(22) Filed: Oct. 28, 2019

(51) Int. Cl. H04R 1/28; H04R 1/10; H04R 19/00; H04R 9/06

(52) U.S. Cl. CPC H04R 1/2857; H04R 1/1016; H04R 9/06; H04R 19/00; H04R 1/1075

(57) ABSTRACT

An earphone can be configured with at least one acoustic driver positioned within an earphone housing. An acoustic driver may be acoustically coupled with an ear canal of a user via two or more airflow pathways that are configured to provide a uniform acoustic impedance from the driver to the user's ear canal.

### SUMMARY

An earphone, in accordance with some embodiments has at least one acoustic driver positioned within an earphone housing. An acoustic driver, such as an electrostatic or planar magnetic driver, is acoustically coupled with the ear canal of a user via two or more airflow pathways that combine to a single pathway that exits the earphone housing to deliver a uniform acoustic impedance from the driver the user's ear canal.

Other embodiments of an earphone consists of an electrostatic, or planar magnetic, driver positioned within a housing and acoustically coupled with the ear canal of a user via two or more parallel pathways of constant cross-sectional area that combine into a single pathway with a cross-sectional area that equals the sum of the cross-sectional area of the aggregate of the smaller pathways to create a uniform acoustic impedance from the driver to the ear canal.

An earphone can be fabricated, in various embodiments, by positioning an acoustic driver within a housing prior to coupling the acoustic driver with an ear canal of a user via a “header.” The header is acoustically connected with two or more tributary airflow pathways that intersect with a collector conduit. The header, each airflow pathway, and collector conduit are configured to provide a uniform acoustic impedance from the acoustic driver to the ear canal.

### BRIEF DESCRIPTION OF THE DRAWINGS

FIG. 1 depicts a block representation of an example earphone system in which various embodiments may be practiced.

FIGS. 2A & 2B depict portions of an example earphone that can be utilized in the earphone system of FIG. 1.

FIGS. 3A-3C respectively depict example acoustic drivers that can selectively be employed in the earphone of FIGS. 1-2B.

FIGS. 4A & 4B respectively depict portions of an example earphone configured in accordance with some embodiments.

FIG. 5 depicts a cross-sectional line representation of an example earphone constructed and operated in accordance with various embodiments.

FIG. 6 depicts portions of an example earphone arranged in accordance with assorted embodiments.

FIGS. 7A-7D depict exploded views of portions of example earphones assembled in accordance with some embodiments.

FIGS. 8A & 8B depict an example accessory that can be employed with the earphone of FIGS. 1-7.

FIG. 9 depicts a cross-section line representation of an example earphone tip.

FIG. 10 is a flowchart of an example of earphone tuning routine that can be carried out in accordance with assorted embodiments.

### DETAILED DESCRIPTION

Assorted embodiments of this disclosure are generally directed to structure and methods of optimizing the acoustic performance of an earphone.

Although placing acoustic drivers proximal to the ear canal of a user has been practiced, no acoustic systems to date have perfectly optimized acoustic reproduction from electrical signals representing sound. It is contemplated that an earphone can employ one or more acoustic drivers that provide an acoustic profile intended to accurately translate electrical signals into sound. It is noted that an earphone is intended to be physically inserted into the ear of a user while a headphone is intended to rest atop, or around, the ear of a user. As such, an earphone may also be characterized as an in-ear monitor (IEM).

In designing IEMs, there are several types of acoustic transducers, such as dynamic, balanced armature, planar magnetic, and electrostatic drivers. Due to their relative low cost, ease of manufacturing, and small physical size, the most common acoustic transducers in IEMs are single or multi-driver implementations of dynamic and/or balanced armature drivers. In rare instances, IEMs using combinations of planar, dynamic, and electrostatic elements have been attempted. IEMs utilizing one or more drivers can provide independent air, and sound, pathways to the ear canal of a user. Alternatively, multiple separate pathways from different drivers can be combined into a single tube prior to exiting an IEM housing.

Regardless of the type of driver utilized in an IEM, past headphones have configured the surface area of the driver being greater than the cross section of the tubing or tapered waveguide pathway that couples the transducer to an exit nozzle of the IEM. Such cross-sectional surface area differences lead to multiple problems, such as reflections at points with abrupt acoustic impedance changes and issues related to the Venturi-effect as air velocity increases when audio waves move through paths of decreasing cross-sectional area.

Some attempts to address these acoustic performance issues employ phase plugs, such as patent application US 2018/0063635, which uses tapered waveguides and/or phase plugs. It is understood that such a waveguides/phase plug design has some inherent limitations, such the fact that tapered waveguides accelerate wave velocity and create potentially choked airflow scenarios and introducing nonlinearities when impedance boundaries exist within the air path, as well as nonlinearities induced by the acoustic impedance mismatch between the phase plug and the ear canal.

As can be seen in the aforementioned examples, existing attempts to cure acoustic performance degradation with tapered waveguides and/or narrow airflow pathways create derivative issues related to impedance boundaries, such as Venturi-effect and audio wave acceleration artifacts. Hence, various embodiments are directed to an earphone system that provides constant acoustic impedance transmission with an airflow line having a cross-sectional area that is tuned to be as close as possible to the cross-sectional area of a user's ear canal as fit and comfort allows so as to minimize impedance boundaries and create a uniform impedance from the headphone driver to the ear drum.

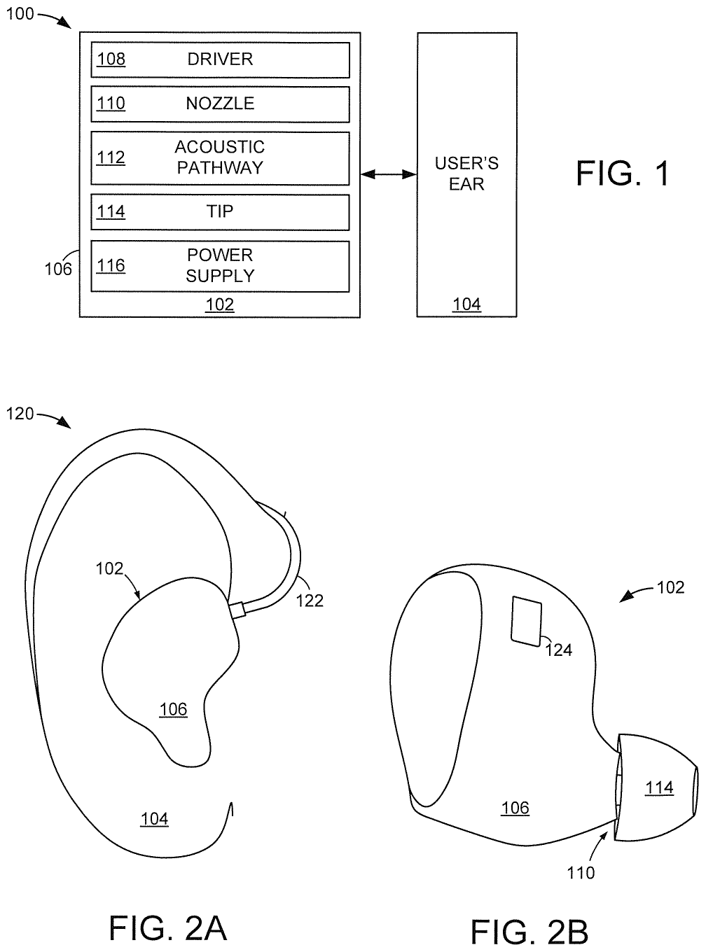

As an IEM nozzle aperture decreases in area, air velocity through the nozzle increases. By way of a non-limiting example, either a tapered waveguide or constant small cross-sectional area tubing that opens into the larger volume of the ear canal both experience an impedance boundary entering the larger cross-sectional area ear canal. As the audio wave enters the user's ear, wave velocity decreases and the attendant pressure change creates a reflected acoustic wave back towards the driver where pressure variation reverses and changes sign while the direction of the pressure wave remains the same. In addition, changes in the cross-sectional area of a tapered waveguide pathway create Venturi effects that can produce standing waves and other problems within the waveguide pathway itself. Turning to the drawings, FIG. 1 depicts a block representation of an example earphone system 100 in which assorted embodiments can be practiced. The system 100 can employ one or more earphones 102 to engage one or more ears 104 of a user. An earphone 102 can have a singular housing 106 containing one or more acoustic drivers 108. It is noted that an earphone 102 can have multiple different types of drivers 108, or multiple drivers 108 of the same type.

Acoustic waves, and pressures, created by the respective drivers 108 are translated to a housing exit nozzle 110 via one or more acoustic pathways 112. The nozzle 110 may physically couple to the ear 104, and/or ear canal, of a user via a pliable tip 114 that selectively attaches to the housing 106 and/or nozzle 110. It is noted that a tip 114 is not always required and the nozzle 110 can be exposed to the ear canal of user without an intervening membrane or other sealing mechanism, such as a gasket, as is the case with a custom molded housing 106.

The respective acoustic driver(s) 108 are supplied with an electrical signal from an audio source that is converted into sound by the driver(s) 108. It is contemplated the audio source is contained within the housing 106, as shown, or positioned outside the housing 106 and connected to the respective driver(s) 108 via one or more wires. A wired electrical connection between the earphone 102 and an audio source may additionally bring electrical power for internal electronics or simply as an interconnect between an appropriate audio amplifier and a completely passive earphone. However, some wireless embodiments provide an electrical power source 116 within the housing 106, such as a battery, capacitor, or mechanical winding.

FIGS. 2A & 2B respectively depict portions of an example earphone system 120 arranged in accordance with various embodiments. FIG. 2A displays a side view of an earphone 102 inserted into the ear 104 of a user. The housing 106 is shaped to ergonomically fit in the ear 104 with the nozzle 110 positioned proximal to, or within, the ear canal of the ear 104 either with a custom molded housing 106 or using a pliable tip 114. It is noted that while a single ear 104 and earphone 102 are displayed, multiple separate earphones 102 can be concurrently employed by a user, such as where one earphone 102 is positioned in each of the user's ears 104.

Although the earphone 102 can be shaped to be secured within the ear 104 autonomously, such as with the pliable, or compressible, tip 114 engaging the ear canal of the ear 104, various embodiments provide a pliable wire 122 that provides electrical signals and electrical power to the earphone 102 while aiding in the physical securement of the earphone 102 in the ear 104. That is, the wire 122 can provide physical support for the earphone 102 to the ear 104, such as non-limiting example wire 122 position of FIG. 2A that wraps around the top of the ear 104. Sometimes, a wire 122 is supported by a pliable metal and wrapped in flexible conduit such that the wire 122 becomes a semi-rigid “hanger” to fit the user's ear 104.

FIG. 2B displays an example earphone 102 with a non-limiting shape that provides ample interior volume to fit one or more drivers 108 along with supporting electronics and acoustic pathways 112. A wire interconnection 124 is provided in the housing 106 to allow the selective attachment, and disconnection, of a wire 122. The ergonomic shape of the housing 106 defines the nozzle 110 so that an attached tip 114 can engage and seal the periphery of an ear canal, which can concurrently physically secure the housing 106 within an ear 104 without a wire 122. It is noted that the nozzle 110 and tip 114 configuration of FIG. 2B is not limiting or required and some earphones 102 replace these components with custom molded features that fit a user's ear 104 exactly.

In order to provide consistent, reliable, and accurate sound reproduction, at least one driver 108 is mounted in an earphone 102. Such physical mounting corresponds with a rigid housing 106 that has a finite volume capable of enabling optimal driver 108 function. Hence, an earphone 102 designer is faced with a choice of driver that fits the housing 106 and provides desired acoustic characteristics when coupled to a user's ear 104. With different acoustic drivers 108 having different acoustic performance and physical sizes, there is an art to designing an earphone 102 that accurately reproduces full-spectrum, low-distortion sound in the limited space available in a housing 106.

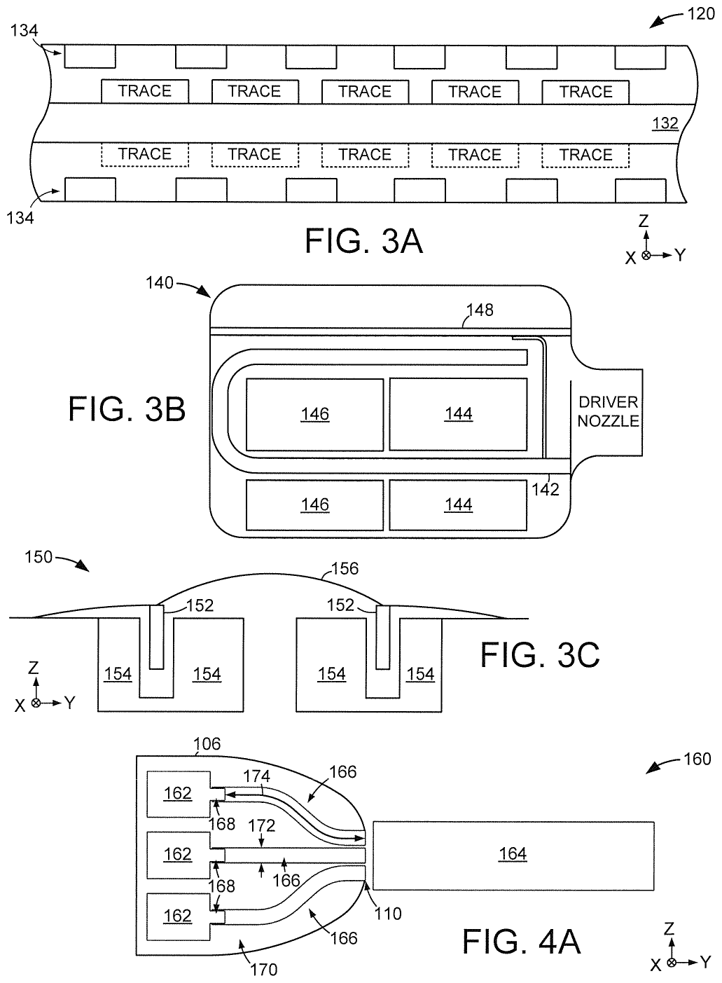

FIGS. 3A-3C respectively depict example acoustic drivers that can be employed in an earphone 102 in accordance with assorted embodiments. An example planar magnetic driver 130 is shown in FIG. 3A. An electrically conductive diaphragm 132 is suspended between magnet arrays 134, which may be placed on one, or both, sides of the diaphragm 132. Such suspension allows the diaphragm 132 to vibrate and move to create acoustic waves and sound in response to electrical signal passing through conductive traces of the diaphragm 132 itself.

The suspension of a diaphragm 132 is also present in an electrostatic driver. However, instead of the diaphragm 132 being electrically energized by current running through traces on the diaphragm 132 and interacting with magnets 134 to produce audio waves, electrostatic drivers place a charged diaphragm 132 with a high bias voltage between one, or two, stators, which would replace the magnet arrays 134 of FIG. 3A and carry an audio signal such that as the audio signal varies on the stators and the diaphragm 132 synchronously moves with the audio signal via electrostatic fields, thereby generating an audio wave.

The electrical energizing of either the diaphragm 132 directly via traces in a planar magnetic driver or via stators in an electrostatic driver can result in very detailed and accurate sound reproduction, but are each difficult to manufacture and are very sensitive to airflow discontinuities, particularly in the tight physical space of an IEM 102. Thus, various embodiments are directed to implementing one or more planar magnetic and/or electrostatic drivers in an earphone 102 with optimized airflow.

In FIG. 3B, an example individual balanced armature driver 140 is illustrated. The driver 140 suspends an armature 142 between magnets 144 that are energized by an electrical coil 146 to induce armature motion. Such motion concurrently moves an attached diaphragm 148 that physically moves to create sound. The conveyance of physical motion from the armature 142 to the diaphragm 148 instead of directly inducing diaphragm 132 motion with electrical current, as in planar magnetic and electrostatic drivers, provides different acoustic performance and capabilities, such as range, clarity, and resonance, than other types of acoustic drivers. The relatively fast action and small physical size of balanced armature drivers 140 allow efficient implementation into an earphone 102.

Another type of driver is the dynamic driver 150 is conveyed in FIG. 3C, which suspends a voice coil 152 proximal a magnet structure 154. Passage of electrical current through the voice coil 152 interacts with the magnet structure 154 to induce motion of an attached diaphragm 156. The relatively large physical range of movement of the voice coil 152 and diaphragm 156 are complemented by the relatively powerful magnet structure 154 to provide adequate sound at low manufacturing cost points that are difficult for other drivers to cost-effectively match. Consequently, a dynamic driver 150 is often implemented into an earphone 102 despite having a relatively large size and often higher harmonic distortion levels and lower resolution than may be achieved with planar magnetic or electrostatic drivers.

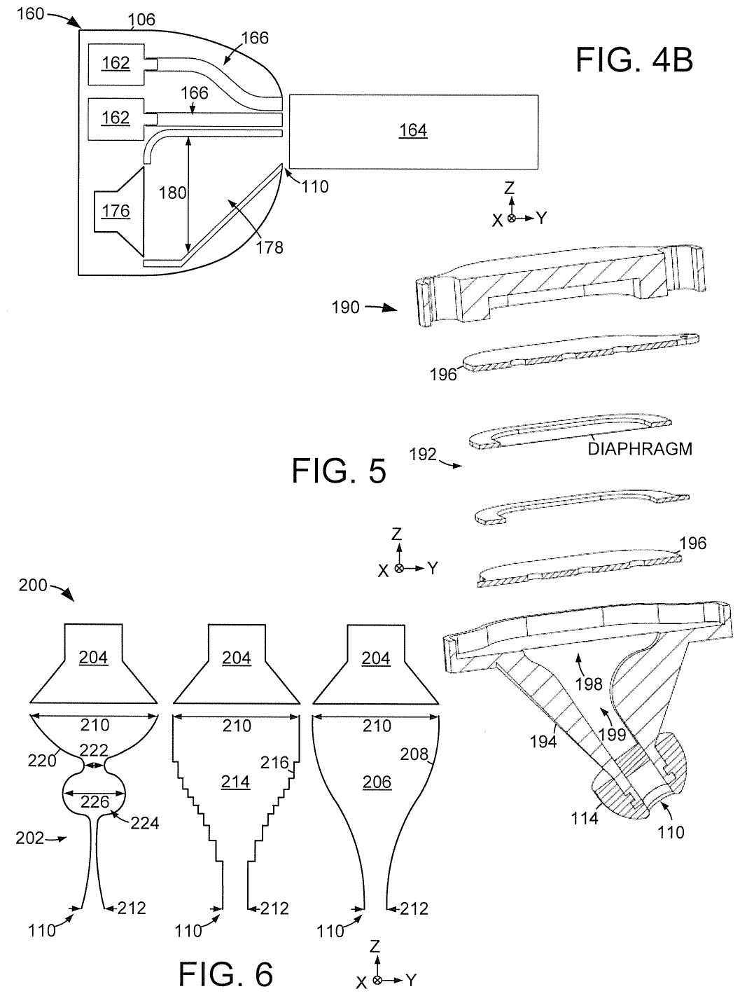

The sophistication of the various types of drivers 130/140/150 has provided continuously improving acoustic performance in smaller physical packages conducive to earphone 102 utilization. However, the opportunity to utilize multiple drivers, and different types of drivers, in an earphone can pose structural and operational difficulties. FIGS. 4A & 4B respectively depict portions of an example earphone 160 configured with different drivers. The earphone 160 of FIG. 4A employs several separate balanced armature (BA) drivers 162 that are each acoustically coupled to a housing nozzle 110 and an ear canal 164 of a user by independent airflow tubes 166. The respective BA drivers 162 can be wired, and operated, in parallel or series with each driver 162 coupled to a tube via a driver exit nozzle 168.

It is noted that the housing 106 of the earphone 160 is sealed in FIG. 4A, but such construction is not required as one or more vents, ports, or valves can be used to provide exterior air into the interior chamber 170 of the housing 106. Alternatively, the earphone housing 106 can have one or more drivers exposed directly to the exterior air. In a non-limiting example, balanced armature drivers can vent into tubes that exit the nozzle of a housing or combine into one common chamber.

The individual airflow tubes 166 of the earphone 160 may have uniform or varying cross-sectional area 172 that can separately exit the nozzle 110 or join into a common collector at the nozzle 110. With the separate tubes 166, the balanced armature drivers 162 can have different tuned acoustic impedances, which can tune the operation and generated sound. In all cases, the cross-sectional area 172 of the respective tubes 166 is determined by the cross-sectional area of the exit nozzle of the balance armature drivers 162. No consideration of the cross-sectional area of the ear canal is factored into the tube cross-sectional area 172.

The term acoustic impedance is meant to be defined by acoustic pressure and air flow volume per unit area, otherwise defined as flow velocity, for a sound wave. The tuning of acoustic impedance for a BA driver 162 can be facilitated by altering the shape, cross-sectional area 172, and/or length 174 of the respective tubes 166. That is, the respective tubes 166 can be individually tuned to provide acoustic impedances that dictate how the BA drivers 162 each operate, which corresponds with the audio performance of the drivers 162 as well as the earphone 160.

While the respective tubes 166 can be tuned through geometric manipulation, the differing physical position of the respective BA drivers 162 relative to the nozzle 110 has historically caused different tubes 166 to have at least different lengths 174 and different acoustic impedances that result in acoustic discontinuities when the BA drivers 162 concurrently operate. While some implementation “time align” acoustic drivers by keeping tube lengths 174 constant, the core issue is the cross-sectional area of the respective tubes 166 is defined by the cross-sectional area of the nozzle 168 and is therefore always much smaller than the cross-sectional area of the ear canal, which creates sharp impedance boundary where the earphone 160 enters the ear canal 164.

The acoustic imperfections and discontinuities attributable to acoustic impedance mismatch in an earphone 160 can be exaggerated when different types of acoustic drivers are used. FIG. 4B illustrates an example of how a dynamic driver 176 can be incorporated into an earphone 160 in combination with multiple BA drivers 162. It is contemplated that a continuous tube, such as tube 166, can be used to acoustically couple the dynamic driver 176 with the exit nozzle 110. However, the relatively broad acoustic spectrum of the dynamic driver 176, along with the strength of the produced acoustic wave and the need to couple a relatively large acoustic drive to a much smaller ear canal, commonly results in a tapered waveguide 178 to be employed to direct acoustic waves from the dynamic driver 176 to the nozzle 110.

As shown, a tapered waveguide has a varying cross-sectional area 180 that concentrates acoustic waves proximal the nozzle 110. The tapered waveguide 178 can be utilized as a collector, in some embodiments, for one or more BA tubes 166. For instance, a BA tube 166 may not continuously extend to the nozzle 110 and instead intersect with the tapered waveguide 178 so that acoustic waves from multiple separate drivers 162/176 commingle and exit the earphone 160 via a single port. It can be appreciated that such collection of acoustic waves from different drivers 162/176 can pose difficult acoustic impedance issues due at least to the fundamentally different operation, acoustic waveform, and optimized airflow characteristics associated with the respective driver types.

The incorporation of other types of drivers into an earphone 160, such as electrostatic or planar magnetic drivers, may further suffer serious constraints from acoustic impedance irregularities and discontinuities due to each driver's susceptibility to variations in air pressure during operation that affect sound quality resulting from extreme variances in acoustic driver compliance between the different driver types.

With planar magnetic drivers, audio from the driver has traditionally either passed through an array of magnets then into a compression chamber or directly into a compression chamber then into one or more tapered waveguides, as discussed in FIG. 3A. The cross-sectional exploded line representation of an example IEM 190 is shown in FIG. 5 and depicts how an electrostatic driver 192 can be incorporated into an in-ear housing 194. With current art, an audio wave originating from the electrostatic diaphragm moves through the stator 196 and then into a compression chamber 198 that opens to a tapered, or straight, waveguide. As a result of the use of the compression chamber 198 exiting via a waveguide 199 that leads to the exit nozzle 110, multiple acoustic impedance boundaries are created that degrade the accuracy and sound of the audio wave, specifically as the air of the audio wave passes through narrow holes in the stator 196 it accelerates then expands and decelerates immediately upon entering the compression chamber 198, then the air compresses and accelerates into the restrictive waveguide, acerbating further as the waveguide narrows, and finally as the wave enters the ear canal it decelerates. For highly sensitive and precise electrostatic and/or planar magnetic drivers, these variations in acoustic impedance can dramatically affect driver operation as the drivers are very compliant and react to reflections from impedance boundaries and Venturi effects, creating frequency and time-domain nonlinearities that cannot be compensated with electronic signal processing that add noise and distortion to the signal.

FIG. 6 depicts an example earphone 200 in which tapered waveguides 202 are tuned to provide customized acoustic impedance in accordance with some embodiments. It is noted that any type of acoustic driver 204, such as a BA, dynamic, electrostatic, or planar magnetic driver, can be employed in the earphone 200 and acoustically coupled to an exit nozzle 110 via a varying cross-sectional area waveguide. It is contemplated that separate drivers 204 are coupled to the nozzle 110 with independent waveguides 202, as shown, or with intersecting waveguides that combine acoustic waves produced by different drivers 204.

The varying cross-sectional area of the respective waveguides 202 can be customized for shape, air volume, and length to provide different acoustic impedances. For instance, the first waveguide 206 can have continuously curvilinear sidewalls 208 that reduce a first cross-sectional area 210 to an exit cross-sectional area 212, which provides a relatively large air chamber proximal the driver 204 and a first acoustic impedance. The example second waveguide 214, utilizes linear sidewalls 216 to reduce the first cross-sectional area 210 to the exit cross-sectional area 212, which can provide a different second acoustic impedance. The non-limiting third waveguide 218 employs curvilinear sidewalls 220 that initially reduce to an intermediate cross-sectional area 222 before enlarging to a pressure/compression chamber 224 having a greater cross-sectional area 226 and subsequently producing the exit cross-sectional area 212, which results in a different third acoustic impedance.

Regardless of the driver 204 type and waveguide configuration, the fact that acoustic waves accelerate and decelerate through a headphone as an audio wave flows from the respective drivers 204 to the nozzle 110 creates acoustic artifacts that inevitably degrade audio performance of the earphone 200. As generally shown with the block representations of FIGS. 4A-5, the surface area of a driver 194, regardless of driver type, is greater than the cross section of the tubing 166 or tapered waveguide 192 that couples the driver 194 to the nozzle 110 of an earphone 190. Such physical configuration produces pressure and velocity gradients resulting in acoustic impedance discontinuities and airflow nonlinearities in the time and frequency domain that degrade driver operation along with acoustic performance.

In embodiments where the size of the nozzle 110 exit aperture decreases in area relative to the surface area of the driver 204 or the waveguides, air velocity through the nozzle 110 increases during driver operation. As such, a uniform cross-sectional area tube 166, or varying cross-sectional area waveguide 202, opens into the larger volume of the ear canal 164, which degrades acoustic performance of the driver(s) and earphone due to the presence of a reflected wave where pressure variation reverses and changes sign while the direction of the pressure wave remains the same. In addition, changes in the cross-sectional area of a tapered waveguide 202 create Venturi effects which may produce standing waves, choke points, and other problems within the waveguide 202 that keep the respective drivers from fulfilling operational, and acoustic, potential.

Accordingly, various embodiments of an earphone create a constant acoustic impedance a driver using a network of tributary airflow pathways of similar cross sectional area with shapes tuned to provide optimal driver performance by consolidating the pathways to a collector having a cross sectional area approximately equal to the sum of the cross-sectional areas of the tributary pathways, thereby creating a constant acoustic impedance from the driver to the ear canal.

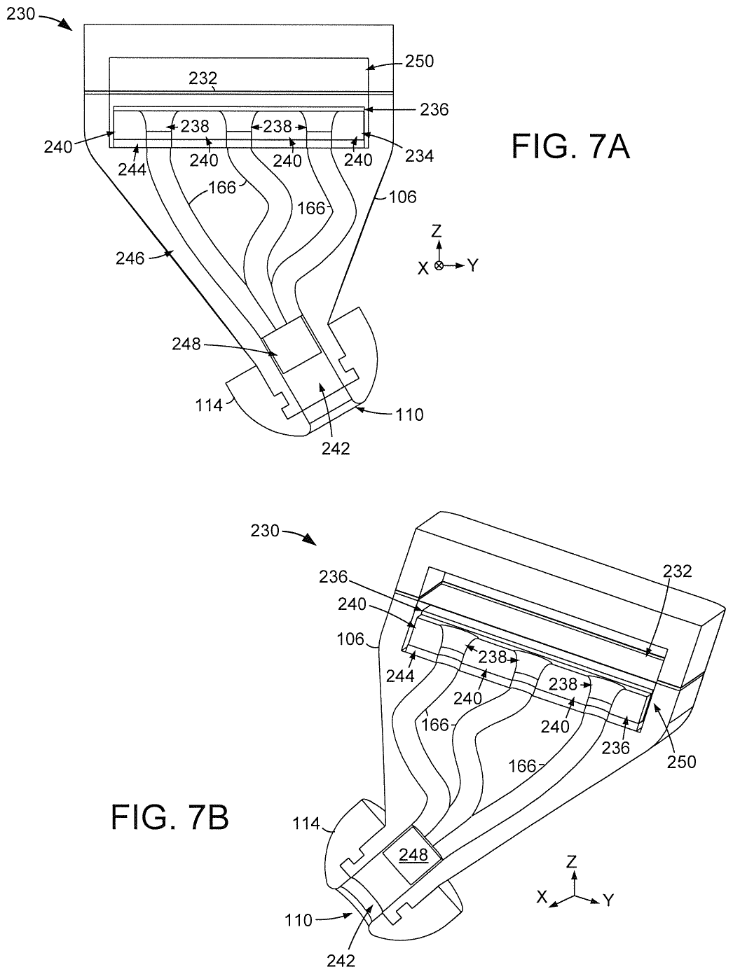

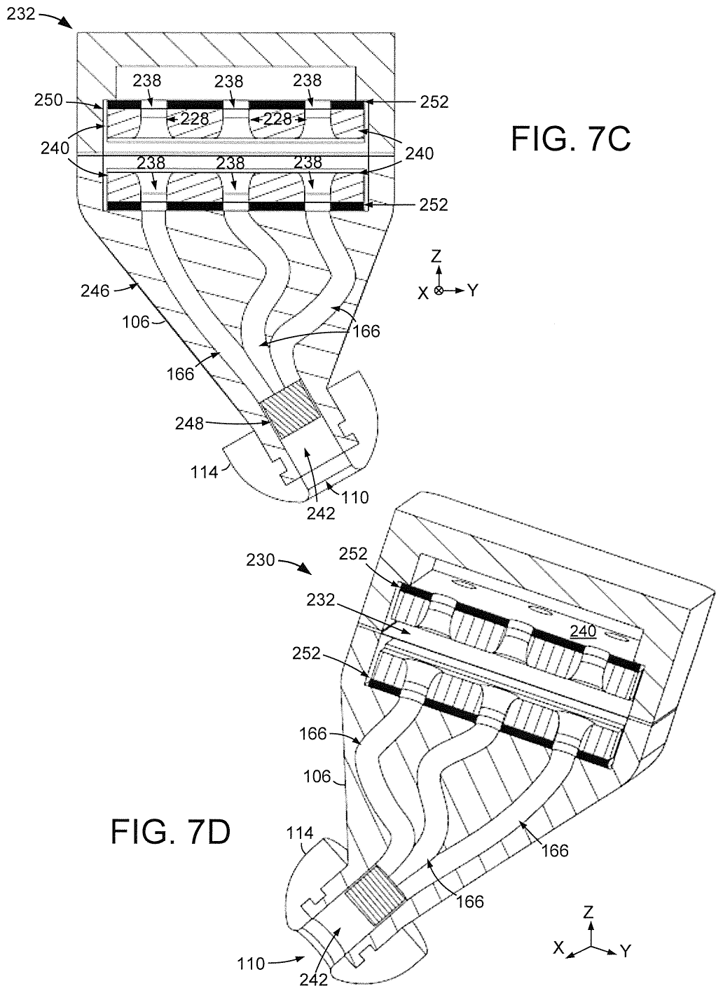

FIGS. 7A-7D respectively depict portions of a non-limiting example earphone 230 that can be utilized in an earphone system in accordance with assorted embodiments. The earphone 230 employs a single planar magnetic diaphragm 232 producing sound that passes a planar magnetic motor 234 that consists of one or more magnets 236 on a pole piece. Sound further passes through ports 238 in response to electronic signals supplied from inside, or outside, the earphone housing 106.

An acoustic header is created by aggregating tubes 166 and may be formed by positioning tubes 166 through the housing 106 material, by molding the tubes 166 around the magnets 236, or placing solid filler material 240 between the magnets 236. The header must include two or more ports 238 that directly couple sound waves from the diaphragm 232 to the nozzle 110 with tubes 166 of effectively constant acoustic impedance designed to ensure the sum of the cross-sectional areas at any set distance from the diaphragm 232 is within +/−15% of the median cross-sectional area considered from start to terminus of the tubes 166 and the collector 242 and nozzle 110. The multiple ports 238 can be tapered, as shown, as well as chamfered or linear, and may go all the way directly to the nozzle 110 or pass through a perforated plate, or tray, 244 holding magnets 236. A plate/tray 244 can be configured with cross-sectional perforations that are each aligned to interface smoothly to tubes 166 to maintain constant acoustic impedance from the diaphragm 232 to the nozzle 110 during diaphragm 232 operation, which contrasts the compression chamber 198/224 feeding the tapered or single straight waveguide, as shown in FIGS. 5 & 6.

It is contemplated that the respective ports 238 can have a uniform or varying cross-sectional area and regular, or irregular, spacing and placement so as to optimize system performance. It is noted that a header comprised of tubes 166 and collector 242 may further consist of fill material that surrounds the respective ports 238 and seals the union of the ports 238 with the driver 250. FIG. 7A is a cross-sectional line representation of the earphone 230 that illustrates how the constant cross-section tubes 166 that connect the perforations in the metal plate 244 and the ports 238 passing through fill, or housing 106, material 240 placed between magnets 236 and directly into the tubes 166 to provide uniform acoustic impedance continuously from the diaphragm 232 to the nozzle 110, which creates a constant impedance air path even as the air flows around, or through, the magnets 236 and other components of the planar magnetic driver 250.

The respective tubes 166 can have matching, or dissimilar, shapes, such as but not limited to round, ovoid, or square, that provide a customized, and uniform, airflow volume and velocity throughout the length of each tube 166 experiences uniform acoustic impedance. The perspective cross-section representation of the earphone 230 in FIG. 7B illustrates how each port 238 provides passage through the metal plate/tray 244 into the respective tubes 166 that each have a uniform cross-sectional area, shape, and length from the header to the collector conduit 242, which matches the acoustic impedance of the tubes 166 by having a cross-sectional area equaling the aggregate cross-sectional areas of the tubes 166.

In the non-limiting embodiment of FIGS. 7A & 7B, each tube 166 is surrounded by rigid material that fills what otherwise could be an open interior cavity 246. That is, the space between the header and nozzle 110 not occupied by the tubes 166 and collector conduit 242 can be rigid material or void of any material. It is noted that a rigid material configuration allows the interior of the earphone to be formed more efficiently than assembly of tubes in a hollow cavity 246, such as with 3D printing, casting, or other deposition.

As shown, but not required or limiting, the collector conduit 242 is filled with an acoustic filter 248 that reduces airflow turbulence from, and extends the effective length of consolidation of audio waves in, the respective tubes 166 while providing additional damping to control diaphragm 232 performance. The filter 248 can partially, or completely, occupy the collector conduit 242 with material that controls airflow while reducing turbulence, such as a foam, fabric, polymer, screen, or lamination thereof. The filter 248 can be configured with a shape and density tuned to provide control of audio wave velocity through the collector conduit 242 while controlling the backpressure and ensuring a constant uniform acoustic impedance for each tube 166 from the diaphragm 232 through the collector conduit 242, which is particularly important when multiple tubes 166 access a single diaphragm 232.

In some embodiments, a filter 248 is selectively inserted, or removed, from the earphone nozzle 110 to modify acoustic impedance of the collector conduit 242, and respective tubes 166. That is, the filter 248 can be configured to be interchangeable by a user to fine tune the impedance of the air path to achieve a desired sonic effect. For instance, a user may listen to an earphone without a filter 248, with a first filter, and then with a second filter having different acoustic impedance characteristics than the first filter to determine which configuration sounds optimal.

It is noted that in the single driver 250 of FIGS. 7A & 7B, the header is meant as the structure downstream from the diaphragm 232 that provides the audio wave path to the exit nozzle 110, such as the perforations in the magnet 236, the respective ports 238, and the respective tubes 166. The ports 238 can be physically attached to, or molded around, a magnet 236. The fill material 240 may be machined, molded, or otherwise shaped to direct non-turbulent airflow into the respective ports 238. The perforated header being placed between magnets 236 creates a nearly flat, perforated surface on the inside of the motor akin to the flat perforated stator 196 of an electrostatic motor, which eliminates typical diffraction affects in planar magnetic motors, such as when air flows through an array of right-angle bar magnets 134.

Alignment of the top surfaces of the magnet/stator 236/196 with the fill material 240 surrounding the entrance to the header ports 238 reduces the occurrence of airflow turbulence at the respective ports 238. It is contemplated that the magnet 236 has an airflow structure disposed between the magnets 236 or stator 196 defined by the ports 238 and tubes 166 that optimizes the passage of air from the diaphragm 232 through the magnet/stator 236/196, such as the subject matter of US patent application No. Flow application ####, which is hereby incorporated herein by reference.

While FIGS. 7A & 7B respectively show a non-limiting example of a planar magnetic earphone 230 where the magnet array is single-ended on the “ear-side” of the diaphragm 232, FIGS. 7C & 7D respectively show other relevant configurations with double-sided magnet arrays 252 where magnets are positioned on the “outer-side” of the diaphragm 232 relative to the nozzle 110 and user's ear canal 164.

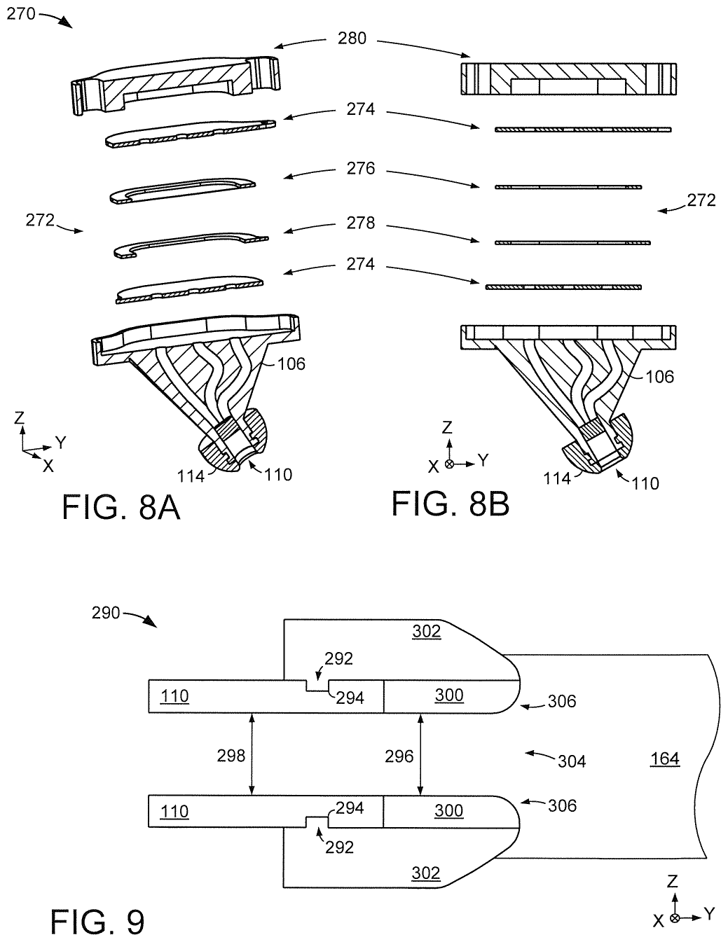

FIGS. 8A and 8B respectively depict exploded line representations of portions of an example electrostatic earphone 270 that can be employed in an earphone system to provide optimized acoustic impedance and performance. FIG. 8A shows an electrostatic configuration where audio from the driver 272 flows through a stator 274 into the respective tubes 166 that provide near constant impedance to the nozzle 110.

It is noted that the non-limiting embodiment of FIGS. 8A & 8B employ an electrostatic driver 272. However, other types of drivers can be utilized instead of, or in combination with, an electrostatic driver 272, such as a dynamic, BA, or planar magnetic driver. A constant acoustic impedance provided by the headers, tubes, conduits, and ports of this disclosure can be applied only to electrostatic and planar magnetic drivers while dynamic and BA drivers would necessarily have variable acoustic impedances, even in an earphone employing a hybrid combination of drivers.

With the electrostatic driver 272 of FIGS. 8A & 8B, a pair of perforated stators 274 are positioned on opposite sides of the diaphragm 276. A bias shim 278 is stretched and bonded to the diaphragm 276 between the respective stators 274. The surface of the bias shim 278 that contacts the diaphragm 276 is charged to a high voltage that energizes a high impedance coating on the diaphragm 276 to create a high voltage static charge causing the driver to move where variable voltage signals are applied to the stators 274. It is contemplated that the respective shim 278 shown in FIGS. 8A & 8B concurrently physically contact the respective stators 274 and the diaphragm 276.

Once assembled, the driver 272 can be incorporated into a sealed housing 106 or a housing 106 that is open to exterior air. In an open housing 106 configuration, the driver 272 is exposed to one or more exterior housing intake apertures extending through the housing 106, capped with an open, vented, or closed rear housing cover 280. In a vented cover, one or more air intake apertures may be mechanically actuated, such as with a manual or air pressure modulated valve. Regardless of the entrance of exterior air into the housing 106, the driver 272 can experience optimal operation due to the uniform acoustic impedance throughout the housing 106 due to the tuned configuration of the airflow tubes 166 and collector conduit 256.

It is noted that unlike prior electrostatic headphones, as generally conveyed in FIG. 5, which can create an acoustic impedance boundaries between the stator and a compression chamber, the compression chamber and a collector, between the collector and a waveguide, between the waveguide and the nozzle 110, and between the nozzle 110 and the user's ear canal 164, the electrostatic driver 272 shown in FIGS. 8A & 8B eliminates the compression chamber and instead directly couples the natural apertures in the respective stators 274 with the tubes 166, thereby eliminating impedance boundaries around the stator 274 and tubes 166 caused by a compression chamber 196.

The shape of the earphone housing 106, and particularly the nozzle 110, can be customized for a variety of purposes. For instance, a housing 106 can be shaped to fit comfortably in a variety of different ears, which can be characterized as a “universal” or “generic” housing. Conversely, a housing 106 can be shaped specifically to fit an ear of a user, which can be characterized as a “custom” housing. In custom housings, a nozzle 110 may be reduced, or removed, compared to a generic housing due to the housing 106 locating an acoustic exit close to, or within, the ear canal.

However, generic housings 106 often do not locate an acoustic exit as close to the ear canal as a custom housing and require a compliant tip to form a seal to the ear canal. Also, the cross-sectional area of the nozzle 110 may not closely match the cross-sectional area of a user's ear canal 164. Hence, the housing nozzle 110 can be configured to receive a tip 114 that physically couples the housing 106 within the ear while at least partially creating a seal between the earphone and the ear canal 164 to further provide optimized acoustic performance.

FIG. 9 depicts a cross-section line representation of an example earphone tip 290 that is secured to an earphone housing nozzle 110 to physically engage the ear canal of a user in accordance with some embodiments. As shown the tip 290 is configured with a securing protrusion 292 that physically engages a notch 294 of the nozzle 110 to allow selective use, and replacement, of a tip 290, which can allow a user to utilize different tip 290 sizes and shapes to provide customized ear fit and comfort.

A tip 290 optimizes an earphone system end-to-end by providing an interior cross-sectional area 296 that is equal to the inner cross-sectional area 298 of the nozzle 110. In contrast to today's earphone tips where a tip cross-sectional area 296 is materially different from the nozzle cross-sectional area 298, a tip cross-sectional area 296, in accordance with various embodiments, matches the nozzle cross-sectional area 298 throughout the length of the tip 290, along the Z axis, ensuring the most consistent and uniform acoustic impedance from earphone driver to ear canal of a user. It is noted that the nozzle cross-sectional area 298 may match the cross-sectional area of a collector conduit 256 to provide a constant acoustic impedance from an earphone driver to a user's ear canal.

While not required or limiting, the tip 290 may be constructed of one or more materials, such as foam, silicone, polymers, rubber, or other compliant materials. Some embodiments configure the tip 290 of a foam material that physically “flares” in response to being inserted into a user's ear yet is designed such that the cross-sectional area stays constant regardless of the geometric distortion caused by the pressure of the user's ear canal 164.

The tip 290 may be constructed of a single material with a unitary form in various embodiments. In other embodiments, a tip 290 can consist of multiple components that may be matching, or dissimilar materials. The non-limiting example tip 290 of FIG. 9 illustrates how a semi-rigid insert 300 is physically positioned within an ear tip body 302. The insert 300 continuously extends from the nozzle 110 to the end of the tip 304 to eliminate any airflow pressure or velocity discontinuities found in tips that suddenly vary the tip cross-sectional area 296.

With the semi-rigid insert 300, the acoustic impedance of the tip is stabilized by maintaining the tip, as defined by cross-sectional area 296, relative to the nozzle cross-sectional area 298, which may deform but still maintain a constant cross-sectional area without being “crushed.” Such configuration contrasts conventionally compliant tips where impedance boundaries are created when the tip cross-sectional area 296 is greater than the nozzle cross-sectional area 298, but the output tip 304 may be significantly smaller in arear if the tip compresses to the point of pinching the user. Insert 300 may be a flexible material that deforms under pressure but maintains cross-sectional area, even if it deflects to an ovoid shape, which contrasts conventional tips that compress and deform in a largely uncontrolled way, such as when the tip cross-sectional area 296 provides a greater cross-sectional area than nozzle cross-sectional area 298.

It is contemplated that an insert 300 may be configured with a uniform cross-sectional area 296 throughout the tip's length or a uniform cross-sectional area 266 until an expansion region 306 where the inner tip cross-sectional area 296 increases to approximate the cross-sectional area of the user's ear canal. The ability to configure the tip 290 with a variety of different configurations complements the ability to selectively replace a tip 290 to increase the likelihood that the uniform and constant acoustic impedance of the earphone matches, or at least is within +1-20%, of the acoustic impedance of the user's ear canal where the tip 302 terminates in the ear anal, whether the user's jaw is closed or partially open.

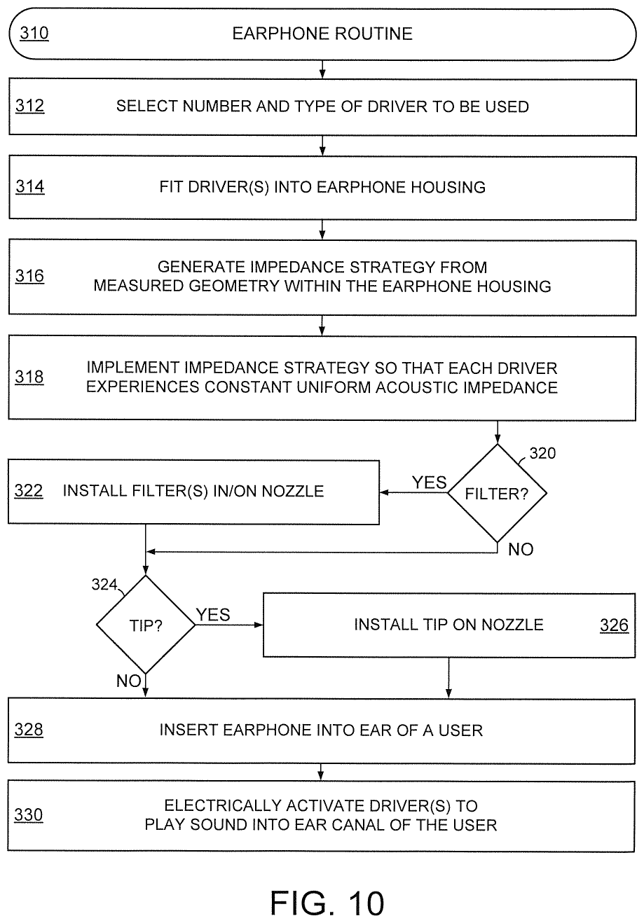

An earphone can be constructed and incorporated into an earphone system in a variety of different manners. FIG. 10 depicts an example earphone routine 310 in which an earphone is constructed and incorporated into an earphone system in accordance with assorted embodiments. The routine 280 begins in the design phase with step 312 selecting the number and type of drivers to be used in an earphone. The result of step 312 may be multiple drivers of the same type being utilized, a single driver being utilized, or multiple different types of drivers being utilized.

The drivers selected in step 312 are then physically fit into a single earphone housing in step 314. Such fitment of step 312 may involve attaching the respective driver(s) to the housing and electrically connecting the driver(s) to an audio source, such as an interconnection 124 or an audio processor positioned within the housing. It is contemplated that an electrical connection may be made to a power source contained within the housing, but such configuration is not required.

Next, step 316 generates an impedance strategy from the measured geometry of the driver(s), and any other equipment, contained within the housing. The impedance strategy can at least generate the number of ports, port shapes, and port sizes for one or more headers along with the cross-sectional area and length of the airflow pathways that will be used to acoustically connect a driver with an exit nozzle of the housing. The impedance strategy may further generate the size and length of a collector conduit in an effort to provide constant and uniform acoustic impedance throughout the airflow path from the driver diaphragm to the ear canal of a user. It is noted that the impedance strategy may select the various dimensions of the airflow pathways to provide a constant acoustic impedance what matches, or approximates within 10%, the acoustic impedance of a user's ear canal when the user has a closed or partially open mouth.

Step 318 proceeds to implement the impedance strategy into the housing so that each driver experiences a constant acoustic impedance during operation and each airflow pathway has the same acoustic impedance throughout the airway's respective length. Decision 320 evaluates if an acoustic filter is to be installed in the nozzle of the housing. An acoustic filter may be positioned within the collector conduit or exterior to the nozzle to reduce airflow turbulence, extend the effective length of the airflow pathways, and provide additional damping to control driver performance.

One or more filters are installed in step 322 to fine tune the uniform acoustic impedance of the earphone. In the event no filter is to be installed, or after the installation of at least one filter from step 322, decision 324 evaluates if a tip is to be employed. If so, step 326 physically attaches a tip to the nozzle of the housing with the tip providing an inner cross-sectional area that matches the inner cross-sectional area of the nozzle, which may be the same as the collector conduit. Step 326 may further involve installing an insert into the tip to provide a varying inner cross-sectional area and/or more closely match the cross-sectional area and acoustic impedance of the user's ear canal.

If the earphone is designed as a custom type earphone where no tip is employed, or after a generic type earphone receives a tip, step 328 inserts the earphone into the ear of a user. It is contemplated that step 328 involves inserting two separate earphones into the respective ears of a single user. Earphone installation can be characterized as physical contact of the earphone with the ear canal of the user's ear, either via a tip or by the housing itself, which can partially, or completely seal the ear canal. Such installation allows step 330 to electrically activate the respective earphone driver(s) to play sound into the ear canal(s) of a user.

Through the various embodiments of an earphone, a uniform acoustic impedance is constantly experienced within the earphone during operation of one or more constituent drivers. The uniform and constant acoustic impedance can be customized with one or more filters and/or tip inserts to match, or closely approximate, the acoustic impedance of a user's ear canal, which optimizes the generation, transmission, and quality of sound waves over time.

In earphone embodiments involving electrostatic driver implementation, airflow tubes align directly to each aperture on one side of the stator, which eliminates the compression chamber and any potential acoustic impedance mismatches within the housing and thereby directly coupling the output of the electrostatic diaphragm to the housing nozzle via a constant impedance pathway.

For planar magnetic driver implementations, an earphone can fill the space between magnets with a perforated material such that air flows between the magnets, then through a perforated metal tray or plate with holes aligned to the perforations, to achieve constant cross-sectional area airflow tube. By directly coupling airflow pathways that pass between the magnets to tubes having a uniform acoustic impedance through the housing to the exit nozzle, sound wave interference during driver operation is severely mitigated or eliminated, which optimizes driver operation and sound quality performance.

It is contemplated that airflow pathways are coupled directly to perforated trays, or plates, in instances where the area between the magnets is better left “clear.” It is further contemplated that when a single-ended motor is produced with the magnets on the far side of the driver from the ear of a user, the airflow tributaries can directly couple to the driver chamber.

While not limiting, the acoustic airflow pathways and conduits of an earphone housing may be identical or have dissimilar cross-sectional shapes, which may be circular, rectangular, oval, rhomboidal, or polygonal. Such pathways and conduits may be symmetric or asymmetric in shape and of varying lengths so as to ensure a sound wave experiences a consistent internal length from the driver diaphragm to a collector conduit/nozzle, which ensures time-alignment of sound waves passing through the respective airflow pathways. Pathway length alignment may be maintained to be within less than 15% of the maximum audio wavelength of interest.

When the airflow pathways combine into a larger collector conduit, the larger conduit's cross section may be within +/−10% of the sum of the area of its tributary tubes. By maintaining near constant cross-sectional area throughout an earphone, an audio wave maintains a near constant velocity that minimizes Venturi effects, wave chokepoints, reflections at acoustic impedance boundaries, and other nonlinear sound wave effects. As such, the need for traditional varying cross-sectional area phase plugs and/or waveguides is eliminated and a virtually ideal frequency response is delivered to a user over time during driver operation. 30

What is claimed is:

1. An apparatus comprising at least one acoustic driver positioned within an earphone housing, the at least one acoustic driver acoustically coupled with an ear canal of a user via one or more airflow pathways that exit the earphone housing to the ear canal, each airflow pathway configured to provide a uniform acoustic impedance from the driver to the ear canal.

2. The apparatus of claim 1, wherein the at least one acoustic driver comprises an electrostatic driver.

3. The apparatus of claim 1, wherein the at least one acoustic driver comprises a planar magnetic driver.

4. The apparatus of claim 1, wherein each airflow pathway converges to a collector proximal a nozzle of the earphone housing, the collector configured to provide the uniform acoustic impedance.

5. The apparatus of claim 4, wherein the collector has a cross-sectional area equal to the aggregate total cross-sectional areas of the respective one or more airflow pathways.

6. The apparatus of claim 4, wherein the collector has a cross-sectional area equal to a cross-sectional area of the ear canal of the user.

7. The apparatus of claim 1, wherein the two or more airflow pathways are each configured to provide the uniform acoustic impedance at any distance from the at least one acoustic driver to a nozzle of the earphone housing.

8. The apparatus of claim 1, wherein the two or more airflow pathways are each configured to provide the uniform acoustic impedance at any distance from the at least one acoustic driver to the ear canal of the user.

9. The apparatus of claim 1, wherein a first length of a first airflow pathway of the two or more airflow pathways is within 15% of a second length of a second airflow pathway of the two or more airflow pathways.

10. The apparatus of claim 1, wherein each airflow pathway has a constant cross-sectional area from the at least one acoustic driver to an exit nozzle of the earphone housing.

11. The apparatus of claim 1, wherein each airflow pathway is aligned with a port extending through a portion of the at least one acoustic driver.

12. An earphone comprising an acoustic driver positioned within a housing, the driver acoustically coupled with an ear canal of a user via two or more airflow pathways that intersect at a collector positioned proximal a nozzle of the housing, each configured to provide a uniform acoustic impedance from the driver to the ear canal.

13. The earphone of claim 12, wherein a filter is positioned within the housing and collector, the filter configured to provide a different acoustic impedance than the uniform acoustic impedance.

14. The earphone of claim 12, wherein the filter is removable from the collector and housing.

15. The earphone of claim 12, wherein each airflow pathway and the collector provide the uniform acoustic impedance constantly from the driver through perforations between multiple magnets and through ports in a tray to the nozzle.

16. The earphone of claim 12, wherein each airflow pathway and the collector provide the uniform acoustic impedance constantly from the driver through perforations in a stator to the nozzle.

17. The earphone of claim 12, wherein a compressible tip is physically coupled to the nozzle, the compressible tip comprising a pliable insert inset that maintains a uniform cross-sectional area from the nozzle to the ear canal of the user despite the tip being compressed into the ear of the user.

18. The apparatus of claim 12, wherein the nozzle and compressible tip maintain a uniform cross-sectional area from the collector to the ear canal of the user.

19. A method comprising:
positioning an acoustic driver within a housing;
coupling the acoustic driver with an ear canal of a user via a header;
connecting the header acoustically with two or more airflow pathways;
intersecting the two or more airflow pathways with at least one collector conduit; and
providing a uniform acoustic impedance from the acoustic driver to the ear canal through the header, each airflow pathway, and each collector conduit.

20. The method of claim 19, wherein an acoustic energy from a diaphragm of the acoustic driver is collected in a plurality of separate zones and time aligned through the use of the two or more airflow pathways.
